(19) United States
(12) Patent Application Publication
(10) Pub. No.: US 2018/0234802 A1
(43) Pub. Date: Aug. 16, 2018

(54) ACTION ANALYSIS METHOD, RECORDING MEDIUM HAVING RECORDED THEREIN ACTION ANALYSIS PROGRAM, AND ACTION ANALYSIS SYSTEM

(71) Applicant: SCREEN HOLDINGS CO., LTD., Kyoto (JP)

(72) Inventor: Itaru FURUKAWA, Kyoto (JP)

(21) Appl. No.: 15/868,960

(22) Filed: Jan. 11, 2018

(30) Foreign Application Priority Data
Feb. 15, 2017 (JP) 2017-025874

(51) Int. Cl. H04W 4/02

(52) U.S. Cl. CPC H04W 4/027

(57) ABSTRACT

A method for analyzing an action of a user of a portable terminal device includes a sensor information obtaining step of obtaining sensor information from one or more sensors mounted on the portable terminal device; a movement determining step of determining movement of the user based on the sensor information; and an action determining step of determining, depending on a determination result obtained in the movement determining step, an action of the user based on the sensor information. In the action determining step, a user's detailed action is determined while referring to various types of profiles (geographic profiles, etc.), depending on the purpose.

### BACKGROUND OF THE INVENTION

### Field of the Invention

The present invention relates to a method for analyzing an action of a user of a portable terminal device.

### Description of Related Art

Information that is obtained by observing what actions are taken by people in streets, in passages in stores, etc., becomes beneficial information for marketing, urban planning, store design, event planning, etc. Hence, conventionally, the collection and analysis of information about people's actions (hereinafter, referred to as “action information”) are performed depending on the purpose.

Conventionally, for example, the collection and analysis of action information are performed using social networking services such as Twitter (registered trademark) and based on posted content called “Tweets”, information on the posting locations of the Tweets, etc. In addition, monitoring of pedestrians' actions using surveillance cameras is also performed. Regarding this, in some cases, images obtained by filming with the surveillance cameras are subjected to analysis by image processing using a computer. Furthermore, analysis of the congestion degree by aggregating pieces of location information obtained from portable terminal devices onto a map is also performed. Moreover, the collection and analysis of action information using questionnaires are also performed.

Note that in relation to inventions of this matter, the following prior art documents are known. Japanese Laid-Open Patent Publication No. 2008-191865 discloses a technique for estimating a target person's action from pieces of information on detection times and on observation areas for each target person which are obtained based on detection by sensors that read an ID of the target person. In addition, Japanese Laid-Open Patent Publication No. 2012-212365 discloses a technique for determining the congestion degree based on the walking pitch and swing detection data of a user of a portable terminal device, etc. In addition, Japanese Laid-Open Patent Publication No. 2014-182611 discloses a technique for determining the attributes of a user based on pieces of information on travel time and travel frequency which are obtained from location information of a portable terminal device.

However, according to the technique using a social networking service, since information cannot be obtained unless posting is performed, only information under circumstances where users can afford to post can be obtained. In addition, it is difficult to secure a sufficient amount of posting for a purpose, and thus, it is difficult to accurately perform statistical analysis. According to the technique using surveillance cameras, surveillance camera installation cost is high. In addition, surveillance camera installation places are often limited and a monitoring range is also limited, and thus, useful information cannot be sufficiently obtained. According to the technique for aggregating location information onto a map, although congestion conditions can be analyzed, people's actions cannot be analyzed. According to the technique using questionnaires, although people's conscious information can be obtained, information about actions that are taken unconsciously cannot be obtained.

### SUMMARY OF THE INVENTION

An object of the present invention is therefore to provide a method for analyzing the actions of users of portable terminal devices (particularly, a method for analyzing what interests the users have) by efficiently obtaining beneficial information about the actions of the users (particularly, actions taken when the users are in a non-walking state).

One aspect of the present invention is directed to an action analysis method for analyzing an action of a user of a portable terminal device, the method including:

a sensor information obtaining step of obtaining sensor information from one or more sensors mounted on the portable terminal device;

a movement determining step of determining movement of the user based on the sensor information; and

an action determining step of determining, depending on a determination result obtained in the movement determining step, an action of the user based on the sensor information.

According to such a configuration, a determination of movement of a user of a portable terminal device is made based on information (sensor information) obtained by sensors mounted on the portable terminal device. By using the sensor information in this manner, user's detailed movement can be grasped. Then, depending on the determination result, a process of determining (estimating) user's movement based on the sensor information is performed. Thus, a user's specific action can be accurately estimated.

Another aspect of the present invention is directed to a computer-readable recording medium having recorded therein an action analysis program for analyzing an action of a user of a portable terminal device, the action analysis program causing a computer to perform:

a sensor information obtaining step of obtaining sensor information from one or more sensors mounted on the portable terminal device;

a movement determining step of determining movement of the user based on the sensor information; and

an action determining step of determining, depending on a determination result obtained in the movement determining step, an action of the user based on the sensor information.

A still another aspect of the present invention is directed to an action analysis system configured by a server and a plurality of portable terminal devices, and analyzing actions of users of the plurality of portable terminal devices, the server and the plurality of portable terminal devices being connected to each other through a network, the action analysis system including:

a movement determining unit configured to determine movement of a user of each portable terminal device based on sensor information obtained from one or more sensors mounted on each portable terminal device; and

an action determining unit configured to determine, depending on results obtained by the determination made by the movement determining unit, an action of the user of each portable terminal device based on the sensor information.

These and other objects, features, modes, and effects of the present invention will be made clear from the following detailed description of the present invention with reference to the accompanying drawings.

### BRIEF DESCRIPTION OF THE DRAWINGS

FIG. 1 is a block diagram showing a device configuration that implements an action analysis system according to a first embodiment of the present invention.

FIG. 2 is a block diagram showing a hardware configuration of a portable terminal device in the first embodiment.

FIG. 3 is a block diagram showing a hardware configuration of a server in the first embodiment.

FIG. 4 is a block diagram showing a detailed functional configuration of the action analysis system in the first embodiment.

FIG. 5 is a flowchart showing a schematic procedure of an action analysis process in the first embodiment.

FIG. 6 is a flowchart showing a procedure of processes performed by the portable terminal device in the first embodiment.

FIG. 7 is a diagram representing Gabor functions for the first embodiment.

FIG. 8 is a diagram for describing display of a component distribution based on the results of a wavelet transform for the first embodiment.

FIG. 9 is a diagram showing a first example of a component distribution in the first embodiment.

FIG. 10 is a diagram schematically showing, by a thick line, a portion in which output intensity greater than or equal to an intensity threshold value appears in the first example of a component distribution in the first embodiment.

FIG. 11 is a diagram showing a second example of a component distribution in the first embodiment.

FIG. 12 is a diagram showing a third example of a component distribution in the first embodiment.

FIG. 13 is a diagram schematically showing, by a thick line, a portion in which output intensity greater than or equal to the intensity threshold value appears in the third example of a component distribution in the first embodiment.

FIG. 14 is a diagram showing a fourth example of a component distribution in the first embodiment.

FIG. 15 is a diagram schematically showing, by a thick line, a portion in which output intensity greater than or equal to the intensity threshold value appears in the fourth example of a component distribution in the first embodiment.

FIG. 16 is a diagram for describing a walking ratio in the first embodiment.

FIG. 17 is a diagram for describing the amount of travel per unit of time in the first embodiment.

FIG. 18 is a diagram for describing the amount of travel per unit of time in the first embodiment.

FIG. 19 is a flowchart showing a procedure of processes performed by the server in the first embodiment.

FIG. 20 is a diagram showing a record format of mesh definition data in the first embodiment.

FIG. 21 is a diagram schematically showing allocation of data to meshes in the first embodiment.

FIG. 22 is a diagram showing an example of a screen displaying a map in the first embodiment.

FIG. 23 is a diagram showing an example of a screen on which pieces of desired information are displayed on a screen displaying a map such that the pieces of desired information are associated with locations on the map in the first embodiment.

FIG. 24 is a diagram showing an example of a screen on which pieces of desired information are displayed on a screen displaying a map such that the pieces of desired information are associated with geographic profiles in the first embodiment.

FIG. 25 is a diagram showing an example of a screen before filtering in the first embodiment.

FIG. 26 is a diagram showing an example of a screen after filtering in the first embodiment.

FIG. 27 is a diagram showing an example in which the occurrence rate of a given action is displayed in hour-by-hour bar graph mode in the first embodiment.

FIG. 28 is a diagram showing an example in which the occurrence rate of a given action is displayed in temperature-by-temperature bar graph mode in the first embodiment.

FIG. 29 is a flowchart showing a procedure of processes performed by the portable terminal device in a second embodiment of the present invention.

### DETAILED DESCRIPTION OF PREFERRED EMBODIMENTS

Embodiments of the present invention will be described below with reference to the accompanying drawings. Note that in the following “application software” is abbreviated as “app”.

### 1. First Embodiment

### <1.1 Overall Configuration>

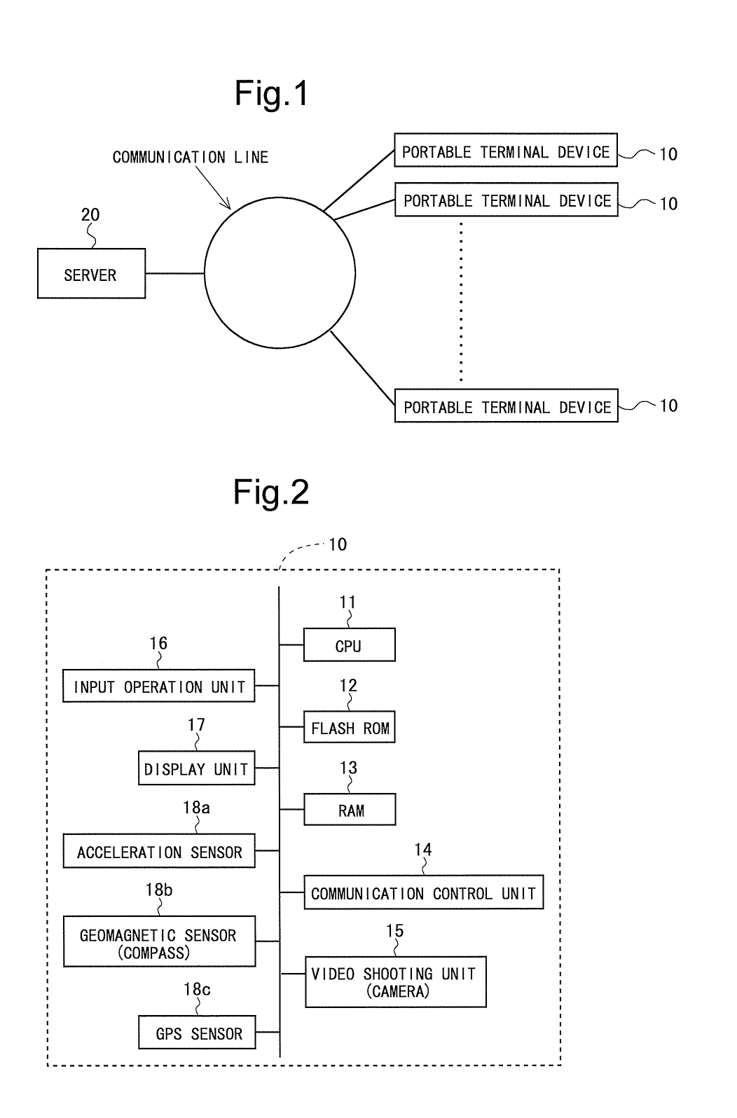

FIG. 1 is a block diagram showing a device configuration that implements an action analysis system according to a first embodiment of the present invention. The action analysis system is implemented by a server 20 and a plurality of portable terminal devices 10. The server 20 and the portable terminal devices 10 are connected to each other through a communication line such as the Internet. An app for implementing the action analysis system is installed on the portable terminal devices 10. In this regard, it is assumed that a tourist guide app is installed on the portable terminal devices 10 as the app for implementing the action analysis system in the present embodiment. By activating the tourist guide app on a portable terminal device 10, the portable terminal device 10 starts a process for analyzing an action of a user thereof (hereinafter, referred to as “user”). Note, however, that the present invention is not limited thereto, and for example, coupon apps for various types of stores (supermarkets, etc.), a map app, a local information provision app, etc., may be installed on the portable terminal devices 10 as the app for implementing the action analysis system. In addition, for example, a function for implementing the action analysis system may be pre-installed on the portable terminal devices 10.

Note that the portable terminal devices 10 as used herein are a concept including not only general mobile phones but also so-called wearable terminals such as a head-mounted display.

### <1.2 Hardware Configuration>

FIG. 2 is a block diagram showing a hardware configuration of the portable terminal device 10. The portable terminal device 10 includes a CPU 11, a flash ROM 12, a RAM 13, a communication control unit 14, a video shooting unit (camera) 15, an input operation unit 16, a display unit 17, an acceleration sensor 18a, a geomagnetic sensor (compass) 18b, and a GPS sensor 18c. The CPU 11 performs various types of arithmetic processing, etc., to control the entire portable terminal device 10. The flash ROM 12 is a nonvolatile writable memory and stores various types of programs and various types of data that need to be held even if the power of the portable terminal device 10 is turned off. The RAM 13 is a volatile writable memory and temporarily stores a program being executed, data, etc. The communication control unit 14 performs control of data transmission to an external source and control of data reception from an external source. The video shooting unit (camera) 15 shoots a view that can be seen from a current location, based on a user's operation. The input operation unit 16 is, for example, a touch panel and accepts user's input operations. The display unit 17 displays images based on an instruction from the CPU 11. The acceleration sensor 18a measures acceleration based on the movement of the portable terminal device 10. The geomagnetic sensor (compass) 18b detects an azimuth in which the portable terminal device 10 is oriented (e.g., an azimuth in which the display unit 17 is oriented). The GPS sensor 18c obtains information on latitude and longitude for identifying a user's current location, based on radio waves received from a GPS satellite.

In the portable terminal device 10, a tourist guide program that implements the tourist guide app is stored in the flash ROM 12. When the user gives an instruction for activating the tourist guide app, the tourist guide program stored in the flash ROM 12 is read into the RAM 13, and the CPU 11 executes the tourist guide program read into the RAM 13, by which a function of the tourist guide app is provided to the user. Note that the tourist guide program is typically downloaded from the server 20 to the portable terminal device 10 through the communication line such as the Internet, and is installed in the flash ROM 12 in the portable terminal device 10. In the present embodiment, an action analysis program for analyzing a user's action is embedded in the tourist guide program. Then, the action analysis program is executed by the CPU 11 in the portable terminal device 10 during a period in which the tourist guide app is used by the user.

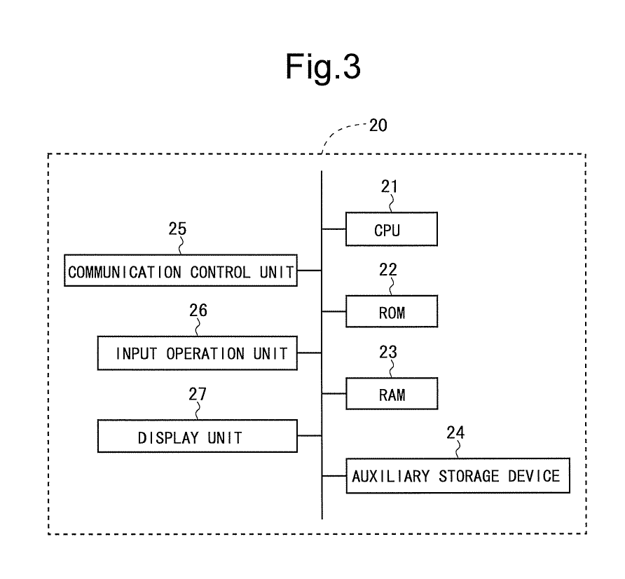

FIG. 3 is a block diagram showing a hardware configuration of the server 20. The server 20 includes a CPU 21, a ROM 22, a RAM 23, an auxiliary storage device 24, a communication control unit 25, an input operation unit 26, and a display unit 27. The CPU 21 performs various types of arithmetic processing, etc., to control the entire server 20. The ROM 22 is a read-only memory and stores, for example, an initial program to be executed by the CPU 21 at startup of the server 20. The RAM 23 is a volatile writable memory and temporarily stores a program being executed, data, etc. The auxiliary storage device 24 is a magnetic disk device, etc., and stores various types of programs and various types of data that need to be held even if the power of the server 20 is turned off. The communication control unit 25 performs control of data transmission to an external source and control of data reception from an external source. The input operation unit 26 is, for example, a keyboard and a mouse and accepts operator's input operations. The display unit 27 displays images based on an instruction from the CPU 21.

In the auxiliary storage device 24 of the server 20, an action analysis program for analyzing a user's action based on data transmitted from each portable terminal device 10 is stored. When the server 20 starts up, the action analysis program stored in the auxiliary storage device 24 is read into the RAM 23, and the action analysis program read into the RAM 23 is executed by the CPU 21.

In the present embodiment, both the portable terminal devices 10 and the server 20 execute the action analysis program for analyzing a user's action. Note, however, that the action analysis program executed on the portable terminal devices 10 and the action analysis program executed on the server 20 are programs that perform different processes.

### <1.3 Functional Configuration>

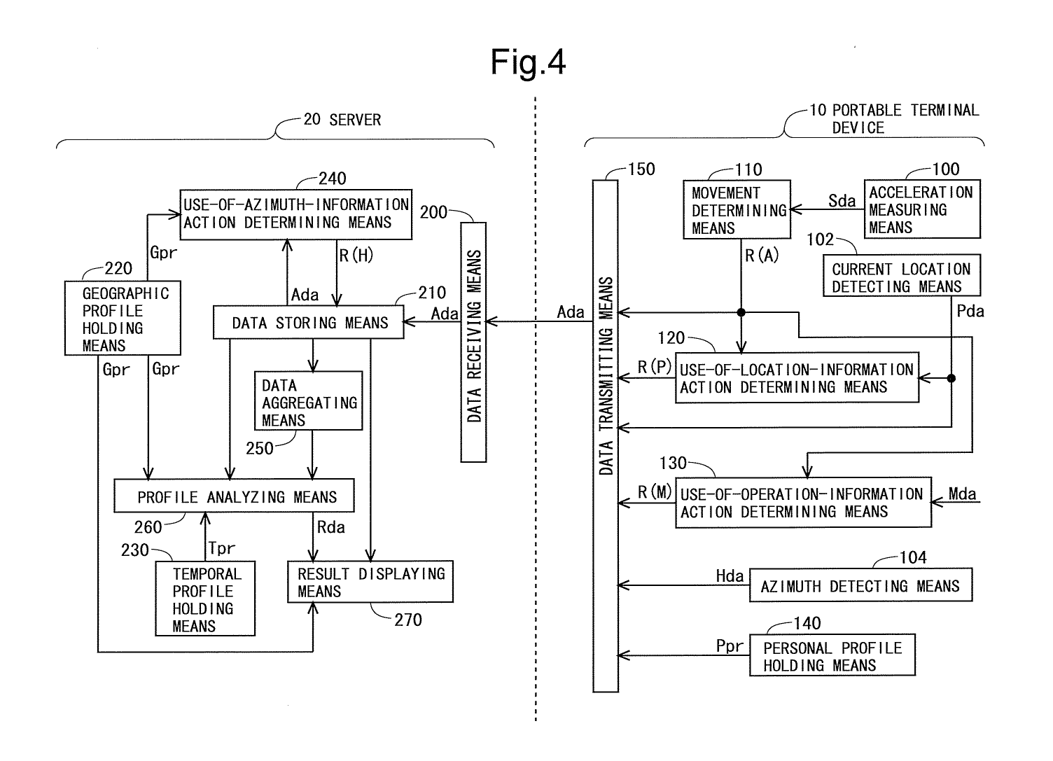

FIG. 4 is a block diagram showing a detailed functional configuration of the action analysis system according to the present embodiment. The action analysis system is implemented by the portable terminal devices 10 and the server 20. Note that although, the tourist guide app is installed on each portable terminal device 10 as described above, FIG. 4 only shows components related to the action analysis program. Each portable terminal device 10 includes acceleration measuring means 100, current location detecting means 102, azimuth detecting means 104, movement determining means 110, use-of-location-information action determining means 120, use-of-operation-information action determining means 130, a personal profile holding means 140, and a data transmitting means 150. The server 20 includes data receiving means 200, data storing means 210, geographic profile holding means 220, temporal profile holding means 230, use-of-azimuth-information action determining means 240, data aggregating means 250, profile analyzing means 260, and result displaying means 270.

Note that, in the present embodiment, a portable-side action determining unit is implemented by the use-of-location-information action determining means 120 and the use-of-operation-information action determining means 130, a server-side action determining unit is implemented by the use-of-azimuth-information action determining means 240, a statistical analyzing means is implemented by the profile analyzing means 260, and an action information displaying means is implemented by the result displaying means 270.

### <1.3.1 Operation of the Components of the Portable Terminal Device>

The operation of each component of the portable terminal device 10 will be described. The acceleration measuring means 100 measures acceleration based on the movement of the portable terminal device 10 which results from user's movement, and outputs a measurement result as acceleration information Sda. Measurement of acceleration by the acceleration measuring means 100 is performed, for example, every 70 milliseconds. The current location detecting means 102 obtains latitude and longitude information for identifying a user's current location based on radio waves received from a GPS satellite, and outputs the latitude and longitude information as location information Pda. The azimuth detecting means 104 detects an azimuth in which the portable terminal device 10 is oriented, and outputs a detection result as azimuth information Hda. Note that the acceleration measuring means 100 is implemented by the acceleration sensor 18a which is hardware, the azimuth detecting means 104 is implemented by the geomagnetic sensor 18b which is hardware, and the current location detecting means 102 is implemented by the GPS sensor 18c which is hardware (see FIG. 2).

The movement determining means 110 determines user's movement based on the acceleration information Sda, and outputs a determination result R(A). Specifically, the movement determining means 110 first determines whether the user is in a walking state or a non-walking state, based on the acceleration information Sda. If, as a result of the determination, the user is in a walking state, the movement determining means 110 determines, based on the acceleration information Sda, whether the state of a user's current location is a congestion state or a non-congestion state. On the other hand, if the user is in a non-walking state, the movement determining means 110 determines user's movement, based on the acceleration information Sda. As described above, the movement determining means 110 in the present embodiment functionally includes walking determining means, use-of-acceleration-information action determining means, and congestion determining means. Note that a more detailed description of the determinations made by the movement determining means 110 will be made later.

The use-of-location-information action determining means 120 determines a user's action, based on the location information Pda and outputs a determination result R(P). The use-of-operation-information action determining means 130 determines a user's action, based on operation information Mda and outputs a determination result R(M). Note that the operation information Mda is information indicating the content of an operation performed by the user on the portable terminal device 10. Examples of the operation information Mda include information indicating that a photo app has been activated and information indicating that a map app has been activated. In the present embodiment, at a given time point, depending on the determination result R(A) obtained by the determination made by the movement determining means 110, either one of the determination by the use-of-location-information action determining means 120 and the determination by the use-of-operation-information action determining means 130 is made. Note that a detailed description of the determination made by the use-of-location-information action determining means 120 and the determination made by the use-of-operation-information action determining means 130 will be made later.

The personal profile holding means 140 holds a personal profile Ppr which is attribute information (information such as age, gender, language used, nationality, and preferences) about the user of the portable terminal device 10. By the personal profile Ppr, for example, the information “(regarding a user of a given portable terminal device 10,) his/her age is 35” is obtained.

The data transmitting means 150 transmits the determination result R(A), the determination result R(P), the determination result R(M), the location information Pda, the azimuth information Hda, and the personal profile Ppr to the server 20. Note that in the following the pieces of information transmitted from the portable terminal device 10 to the server 20 are collectively referred to as “analysis data”. The analysis data is given reference character Ada. Time intervals at which the transmission of analysis data Ada by the data transmitting means 150 (i.e., the transmission of analysis data Ada from the portable terminal device 10 to the server 20) is performed are determined depending on the purpose of analysis, etc. It is assumed that the transmission of analysis data Ada by the data transmitting means 150 is performed every five minutes in the present embodiment.

### <1.3.2 Operation of the Components of the Server>

Next, the operation of each component of the server 20 will be described. The data receiving means 200 receives analysis data Ada which is transmitted from each portable terminal device 10. The analysis data Ada is stored in the data storing means 210. The data storing means 210 holds the analysis data Ada and determination results R(H) obtained by a determination made by the use-of-azimuth-information action determining means 240 which will be described later.

The geographic profile holding means 220 holds a geographic profile Gpr in which location information (latitude and longitude information) is associated with geographic attribute information. Examples of attribute information held as a geographic profile Gpr include the type of store, the type of facility, and the state of a road (road width, a corner, a traffic light, a crosswalk, stairs, or a sloping road). By the geographic profile Gpr, for example, the information “there is a supermarket at a location with a given latitude and longitude” is obtained.

The temporal profile holding means 230 holds a temporal profile Tpr in which information on time (time and month/day/year) is associated with various types of attribute information. Examples of attribute information held as a temporal profile Tpr include a season, a day of the week, weather, temperature, and whether there is an event. By the temporal profile Tpr, for example, the information “(regarding a given region,) it was rainy weather from 8 a.m. to 11 a.m. on Jan. 15, 2017” is obtained.

The use-of-azimuth-information action determining means 240 determines an action of a user that is determined to be in a non-walking state (stopping) from a determination result R(A) included in the analysis data Ada, based on the geographic profiles Gpr and azimuth information Hda included in the analysis data Ada, and outputs a determination result R(H). The determination result R(H) is stored in the data storing means 210. Note that a detailed description of the determination made by the use-of-azimuth-information action determining means 240 will be made later.

The data aggregating means 250 aggregates the data (various types of determination results, etc.) held in the data storing means 210, on a mesh-by-mesh basis. The profile analyzing means 260 statistically analyzes actions of users (users of the plurality of portable terminal devices 10) based on the data held in the data storing means 210, the data aggregated by the data aggregating means 250, the geographic profiles Gpr, and the temporal profiles Tpr. Note that a detailed description of the analysis performed by the profile analyzing means 260 will be made later.

The result displaying means 270 displays pieces of information indicating users' actions on the display unit 27 based on the data held in the data storing means 210 or based on results Rda obtained by the analysis performed by the profile analyzing means 260. At that time, the result displaying means 270 can display the pieces of information indicating users' actions on a screen displaying a map such that the pieces of information are associated with locations on the map. In addition, the result displaying means 270 can display the pieces of information indicating users' actions on a screen displaying a map such that the pieces of information are associated with geographic profiles Gpr.

### <1.4 Action Analysis Method>

Next, an action analysis method in the present embodiment will be described.

### <1.4.1 Summary>

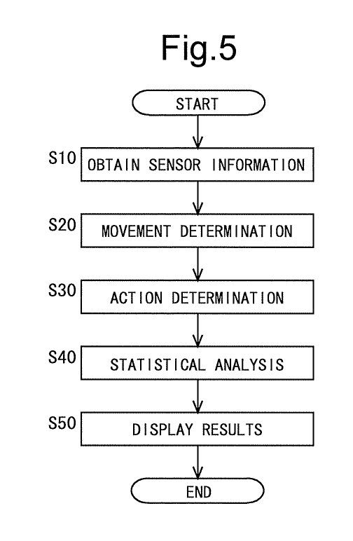

FIG. 5 is a flowchart showing a schematic procedure of an action analysis process in the present embodiment. First, each portable terminal device 10 obtains sensor information (S10). In the present embodiment, acceleration information Sda, location information Pda, and azimuth information Hda are obtained as the sensor information. As for the obtaining of sensor information at this step S10, data is obtained at very short time intervals (e.g., 70-millisecond intervals), depending on the capability of each sensor, etc.

Then, each portable terminal device 10 makes a determination as to what user's movement is like (movement determination) (step S20). Note that the “movement” as used herein simply refers to the magnitude of body movement, and does not refer to behavior (act) that is performed with some kind of purpose.

Then, depending on a result of the movement determination, a determination for a user's detailed action is made based on the sensor information (step S30). In the present embodiment, the determination (action determination) at this step S30 is performed on either the portable terminal devices 10 or the server 20, depending on the sensor information used for the determination. Thereafter, regarding users' actions, statistical analysis using various types of profiles (geographic profiles Gpr, time profiles Tpr, and personal profiles Ppr) is performed based on the results obtained at step S20 and S30 (step S40). Then, based on an operation by an operator of the server 20, information indicating users' actions is displayed on a screen (step S50).

Meanwhile, regarding the action determination at step S30, in the present embodiment, a determination that can be made based only on information obtained by the portable terminal device 10 is made by the portable terminal device 10, and other determinations are made by the server 20. The following specifically describes processes performed by the portable terminal devices 10 and processes performed by the server 20.

### <1.4.2 Processes Performed by the Portable Terminal Devices>

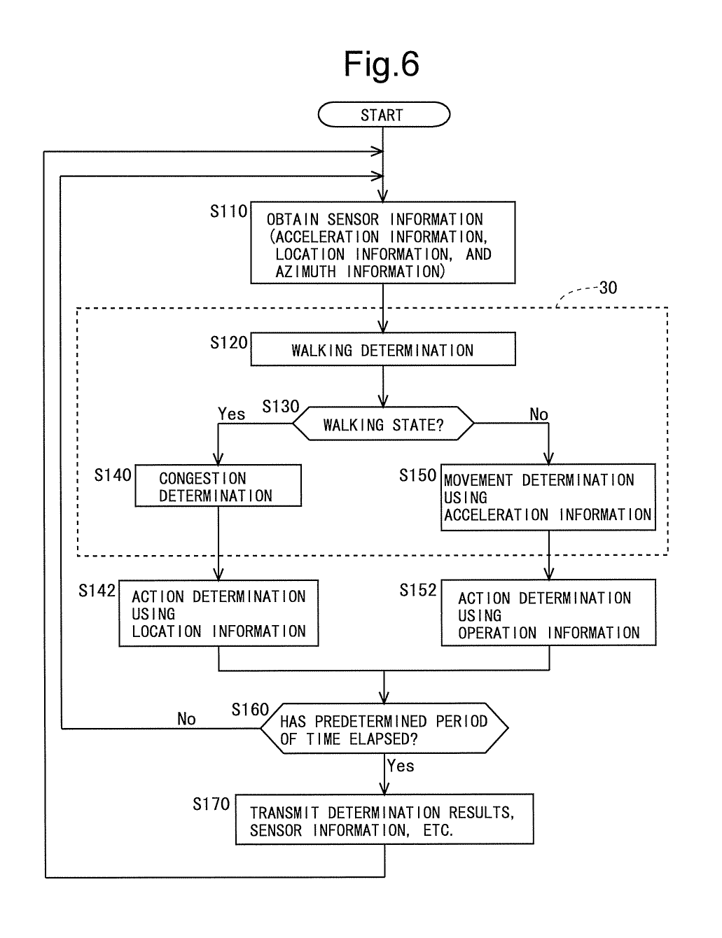

FIG. 6 is a flowchart showing a procedure of processes performed by each portable terminal device 10. When a tourist guide app is activated on the portable terminal device 10, first, sensor information is obtained (step S110). In the present embodiment, specifically, acceleration information Sda, location information Pda, and azimuth information Hda are obtained. Note that these pieces of information are obtained at any time.

Then, the movement determining means 110 determines whether a user of the portable terminal device 10 is in a walking state or a non-walking state (step S120). The determination at this step S120 is made based on a result that is obtained by performing frequency analysis on the acceleration information Sda.

In the present embodiment, as specific means for performing frequency analysis, wavelet analysis is adopted. Wavelet analysis is frequency analysis means for performing a process (wavelet transform) of computing the inner product of a function (wavelet function), which is obtained by stretching or shrinking and shifting a function called a mother wavelet in a time-axis direction, and a signal to be analyzed, and thereby obtaining a component distribution for combinations of time and frequency for the signal to be analyzed. With a Fourier transform which is generally used as means for analyzing the frequency of a signal, a temporal change in each frequency component cannot be obtained, whereas with a wavelet transform, a temporal change in each frequency component can be obtained.

In general, a wavelet transform W(a, b) is represented by the following equation (1):

W(a, b)=∫_{-∞}^{∞}ψ_{a, b}(t)f(t)dt (1)

Regarding the above equation (1), ψ_{a, b}(t) represents a wavelet function, f(t) represents a signal to be analyzed (in the present embodiment, acceleration information Sda), a represents a parameter (scale parameter) proportional to the reciprocal of a frequency, and b represents a parameter (shift parameter) proportional to time. That is, W(a, b) represents output intensity for a combination of time and frequency.

The wavelet function ψ_{a, b}(t) in the above equation (1) is generated by stretching or shrinking and shifting a mother wavelet ψ in the time-axis direction as shown in the following equation (2):

$${ψ}_{a , b} ( t ) = \frac{1}{\sqrt{a}} ψ ( \frac{t - b}{a} ) d t \qquad ( 2 )$$

Note that by substituting the above equation (2) into the above equation (1), the following equation (3) is obtained:

$$W ( a , b ) = \frac{1}{\sqrt{a}} {\int }_{- ∞}^{∞} f ( t ) ψ ( \frac{t - b}{a} ) d t \qquad ( 3 )$$

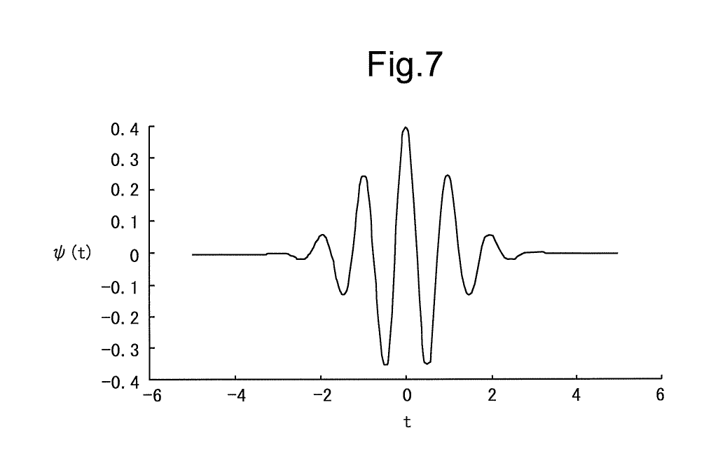

Meanwhile, in the present embodiment, as the mother wavelet, a “Gabor mother wavelet” which is represented by the following equation (4) is used. The Gabor mother wavelet (Gabor function) is represented as shown in FIG. 7, and is known to be suitable for detection of a local frequency component of a signal.

$$ψ ( t ) = \frac{1}{\sqrt{2 π {σ}^{2}}} exp ( - \frac{{t}^{2}}{2 {σ}^{2}} ) exp ( - i ω t ) \qquad ( 4 )$$

For the above equation (4), σ represents an attenuation coefficient, i represents an imaginary number, and ω represents angular velocity. Note that expZ means Zth power of e (the base of the natural logarithm).

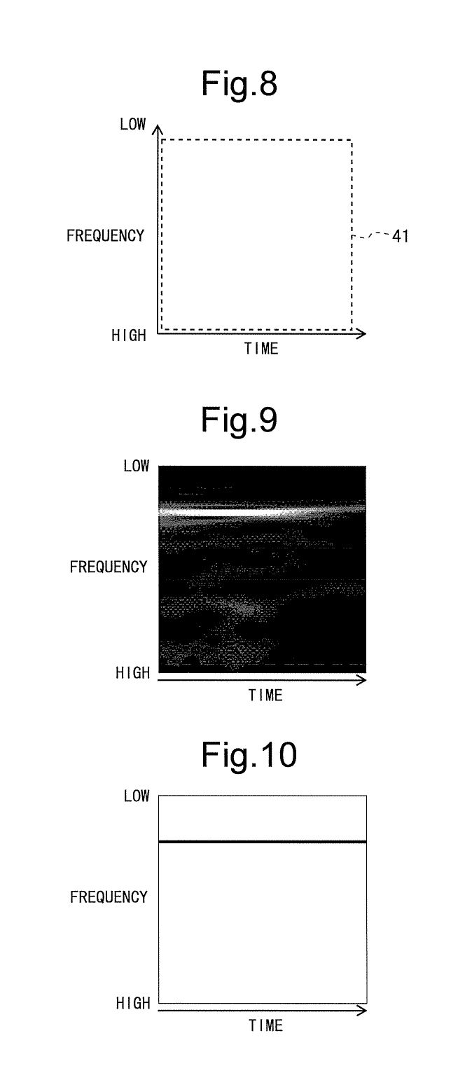

According to such a wavelet transform, a component distribution for combinations of time and frequency is obtained as described above. In general, when this component distribution is depicted, a graph with frequency on the vertical axis and time on the horizontal axis (see FIG. 8) is used, and output intensity (the intensity of a component) is represented by brightness in a region corresponding to combinations of time and frequency (a region indicated by reference character 41 in FIG. 8).

In the present embodiment, a wavelet transform using a Gabor mother wavelet is performed on acceleration information Sda which is obtained for a predetermined period of time by the acceleration measuring means 100 (acceleration sensor 18a). Note that a target period for this single process (a period corresponding to the above-described predetermined period of time) is hereinafter referred to as “analysis target period”. In the walking determination process (the process at step S120), attention is focused on a period (hereinafter, referred to as “presumed walking period”) during which the output intensity is greater than or equal to a predetermined threshold value in a frequency band in which the user is considered to be in a walking state, and it is determined whether the user is in a walking state or in a non-walking state, taking into account a ratio (hereinafter, referred to as “walking ratio”) of the length of the presumed walking period to the length of the analysis target period. A detailed description is made below.

According to the wavelet transform, a temporal change in output intensity can be obtained for a wide frequency band range. However, it is considered that when the user is walking in a steady state, a strong peak of the output intensity appears in a given limited frequency band range. Hence, in the present embodiment, a frequency band in which it is considered that a strong peak appears when the user is walking in a steady state is set as an analysis target frequency band, and attention is focused only on data on frequencies included in the analysis target frequency band. Specifically, when a wavelet transform is performed on acceleration information Sda, the scale parameter a in the above equation (1) is changed such that output intensity (output intensity for combinations of time and frequency) is obtained only for frequencies included in the analysis target frequency band. In addition, the shift parameter b in the above equation (1) is changed such that output intensity for each desired time in the analysis target period is obtained. By thus changing the scale parameter a and the shift parameter b as appropriate when performing a wavelet transform on acceleration information Sda, data that is required to determine whether the user is in a walking state or in a non-walking state is effectively extracted.

In addition, even when a peak of the output intensity is continuously observed throughout the analysis target period, if the output intensity of the peak is low, then the peak is not necessarily caused by walking action. Hence, in the present embodiment, attention is focused on data in which the output intensity is greater than or equal to a certain threshold value in the analysis target frequency band. Specifically, a threshold value (hereinafter, referred to as “intensity threshold value” for convenience sake) for comparing with the output intensity is set in advance, and a period during which the output intensity is greater than or equal to the intensity threshold value in the analysis target frequency band is set as the above-described presumed walking period.

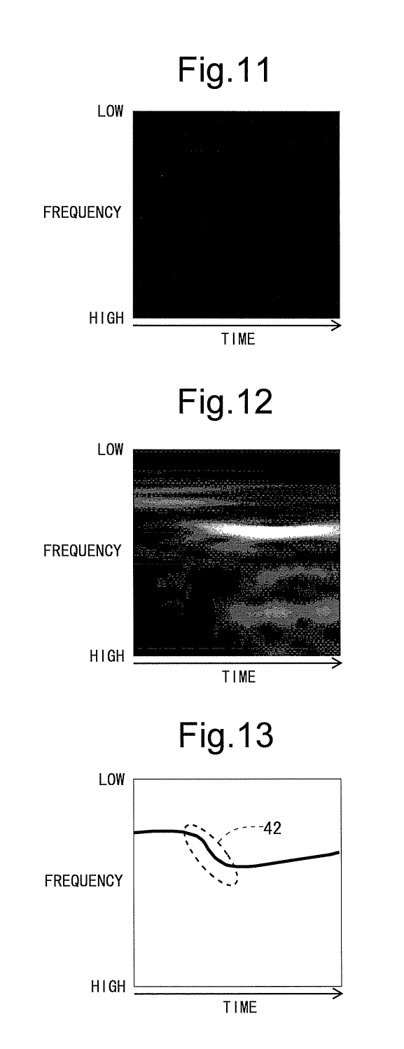

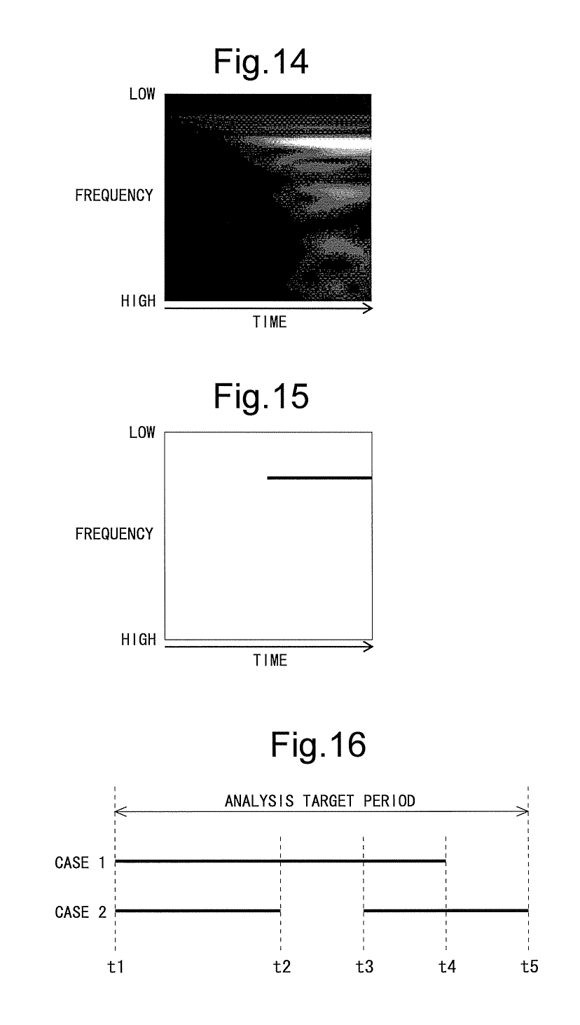

Here, examples of component distributions which are obtained by performing a wavelet transform on acceleration information Sda are shown. FIG. 9 is a diagram showing a first example of a component distribution. FIG. 10 is a diagram schematically showing, by a thick line, a portion in which output intensity greater than or equal to the intensity threshold value appears in the first example. The first example is an example for when the user is walking in a steady state throughout the analysis target period. In the first example, the walking ratio is 100%. FIG. 11 is a diagram showing a second example of a component distribution. In the second example, there is no portion in which output intensity greater than or equal to the intensity threshold value appears. That is, the walking ratio is 0%. FIG. 12 is a diagram showing a third example of a component distribution. FIG. 13 is a diagram schematically showing, by a thick line, a portion in which output intensity greater than or equal to the intensity threshold value appears in the third example. The third example is an example for when a temporary change has occurred in walking speed for some reason during walking in a steady state. In the third example, the walking ratio is 100%. FIG. 14 is a diagram showing a fourth example of a component distribution. FIG. 15 is a diagram schematically showing, by a thick line, a portion in which output intensity greater than or equal to the intensity threshold value appears in the fourth example. The fourth example is an example for when the user has started walking action in the middle of the analysis target period. In the fourth example, the walking ratio is about 50%.

Meanwhile, a period (presumed walking period) during which the output intensity is greater than or equal to the above-described intensity threshold value in the analysis target period is not always one uninterrupted period, which will be described with reference to FIG. 16. In FIG. 16, a presumed walking period is represented by a thick line. In case 1, a presumed walking period is one uninterrupted period (continuous period). In this case 1, the ratio of the “length of a period from time point t1 to time point t4” to the “length of a period from time point t1 to time point t5” is a walking ratio. In case 2, a part of the first half period of the analysis target period and a part of the second half period of the analysis target period are presumed walking periods. In this case 2, the ratio of the “sum of the length of a period from time point t1 to time point t2 and the length of a period from time point t3 to time point t5” to the “length of a period from time point t1 to time point t5” is a walking ratio.

In the present embodiment, a threshold value (hereinafter, referred to as “ratio threshold value” for convenience sake) for comparing with a walking ratio such as that described above is determined in advance. Then, in the walking determination process (the process at step S120), the walking ratio is compared with the ratio threshold value. If the walking ratio is greater than or equal to the ratio threshold value, it is determined that “the user is in a walking state”. If the walking ratio is less than the ratio threshold value, it is determined that “the user is in a non-walking state”.

If it is determined, as a result of the walking determination process (the process at step S120) such as that described above, that “the user is in a walking state”, processing proceeds to step S140, and if it is determined that “the user is in a non-walking state”, processing proceeds to step S150 (step S130) (see FIG. 6). Note that although a walking determination is made based on a result that is obtained by performing frequency analysis on the acceleration information Sda as described above in the present embodiment, the present invention is not limited thereto, and a walking determination may be made by other techniques. For example, a walking determination can also be made using the azimuth information Hda, angular velocity information, etc.

At step S140, the movement determining means 110 makes a determination (congestion determination) as to whether the state of a user's current location is a congestion state or a non-congestion state. At this step S140, first, for example, standard deviation of acceleration for the last 10 seconds is calculated. In general, when a person is walking in a crowded place, he/she walks with short steps and his/her overall movement is small, resulting in small variations in acceleration. On the other hand, when a person is walking in an uncrowded place, he/she walks with long steps and his/her overall movement is large, resulting in large variations in acceleration. As such, variations in acceleration change depending on the degree of congestion. Hence, at step S140, a congestion determination is made using standard deviation (of acceleration) serving as an index for variations in acceleration. Specifically, a threshold value for comparing with the standard deviation is prepared, and determinations such as those described in the following (A-1) to (A-2) are made.
(A-1): If the standard deviation is less than the threshold value, it is determined that “the state of the user's current location is a congestion state”.
(A-2): If the standard deviation is greater than or equal to the threshold value, it is determined that “the state of the user's current location is a non-congestion state”.

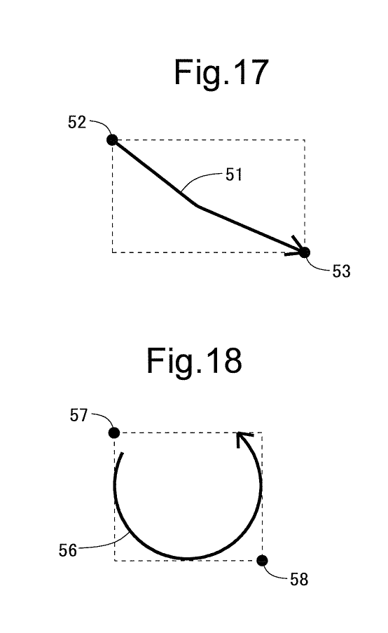

After the completion of the congestion determination, the use-of-location-information action determining means 120 makes an action determination using the location information Pda (S142). At this step S142, first, the amount of user's travel per unit of time (e.g., five seconds) is obtained based on the location information Pda. Meanwhile, the user does not always walk (travel) linearly during a unit of time. Hence, the amount of travel (the amount of travel per unit of time) is, for example, the distance between the upper left coordinates and lower right coordinates of a minimum rectangular range that includes the entire travel range. For example, when the user travels in a manner indicated by an arrow given reference character 51 in FIG. 17 during a unit of time, the distance of a straight line connecting coordinates 52 to coordinates 53 is set as the amount of travel. In addition, for example, when the user travels in a manner indicated by an arrow given reference character 56 in FIG. 18 during a unit of time, the distance of a straight line connecting coordinates 57 to coordinates 58 is set as the amount of travel. Note, however, that the present invention is not limited thereto, and for example, the actual total travel distance may be set as the amount of travel, or the distance of a straight line connecting a start point to an end point may be set as the amount of travel. At step S142, based on the amount of travel per unit of time which is obtained in the above-described manner, a determination is made to estimate a user's detailed action. At this step S142, for example, determinations such as those described in the following (B-1) to (B-2) are made. Note, however, that the present invention is not limited to examples shown below, and it is sufficient to make determinations depending on the purpose.

The amount of travel per unit of time is compared with a predetermined threshold value, and when the amount of travel is less than the threshold value, determinations described in the following (B-1) to (B-2) are made.
(B-1): If the amount of travel is less than or equal to 10 cm per second, it is determined that “the user is stuck in a huge congestion”.
(B-2): If it is determined (using data obtained during a predetermined period of time before this step S142 is performed) that the user is traveling only within an area in a given range, it is determined that “the user is interested in the area”.

On the other hand, at step S150, the movement determining means 110 makes a movement determination using the acceleration information Sda. At this step S150, as with the above-described step S140, first, standard deviation of acceleration is calculated. Then, a threshold value for comparing with the calculated standard deviation is prepared, and determinations such as those described in the following (C-1) to (C-2) are made.
(C-1): If the standard deviation is less than the threshold value, it is determined that “the user is staying at a corresponding place (e.g., something that attracts user's interest such as a tourist object or a commodity is present at the corresponding place)”.
(C-2): If the standard deviation is greater than or equal to the threshold value, it is determined that “the user is walking as stopping sometimes, e.g., doing window shopping”.

After the completion of the movement determination using the acceleration information Sda, the use-of-operation-information action determining means 130 makes an action determination using operation information Mda (S152). Note that the operation information Mda is obtained at appropriate timing. At this step S152, for example, determinations such as those described in the following (D-1) to (D-2) are made. Note, however, that the present invention is not limited to examples shown below, and it is sufficient to make determinations depending on the purpose are made.
(D-1): If information indicating that a photo app has been activated is obtained as the operation information Mda, it is determined that “the user is taking a photo”.
(D-2): If information indicating that a map app has been activated is obtained as the operation information Mda, it is determined that “the user is lost”.

After the completion of step S142 or S152, it is determined whether a predetermined period of time has elapsed since the last transmission of various types of determination results, sensor information, etc., to the server 20 (step S160). If, as a result of the determination, the predetermined period of time has elapsed, processing proceeds to step S170, and if the predetermined period of time has not elapsed, processing returns to step S110. Note that, in the present embodiment, at step S160, it is determined whether five minutes have elapsed since the last transmission of determination results, sensor information, etc., to the server 20.

At step S170, data (various types of determination results, sensor information, etc.) accumulated during the predetermined period of time is transmitted from the portable terminal device 10 to the server 20, as the above-described analysis data Ada. By the above-described process at step S160, in the present embodiment, analysis data Ada is transmitted from the portable terminal device 10 to the server 20 every five minutes. After transmitting the analysis data Ada to the server 20, processing returns to step S110. Thereafter, the processes at step S110 to S170 are repeated until the portable terminal device 10 terminates the use of the tourist guide app.

Meanwhile, the transmission of analysis data Ada to the server 20 is performed every five minutes, and the walking determination at step S120 is made every predetermined unit of time. It is assumed that the walking determination at step S120 is made every five seconds in the present embodiment. Then, depending on the walking determination made every five seconds, the congestion determination at step S140, the action determination at step S142, the movement determination at step S150, and the action determination at step S152 are made. Therefore, if the user is in a walking state throughout five minutes from when transmission of analysis data Ada to the server 20 is performed to when the next transmission of analysis data Ada to the server 20 is performed, then the congestion determination at step S140 and the action determination at step S142 are made every five seconds throughout the five minutes. In addition, regarding the five minutes, if the user is in a walking state for the first three minutes and is in a non-walking state for the last two minutes, then the congestion determination at step S140 and the action determination at step S142 are made every five seconds during the first three minutes, and the movement determination at step S150 and the action determination at step S152 are made every five seconds during the last two minutes.

Note that processes included in a dotted-line box given reference character 30 in FIG. 6 (the processes at step S120, S130, S140, and S150) correspond to the process at step S20 in FIG. 5 (movement determination process).

### <1.4.3 Processes Performed by the Server>

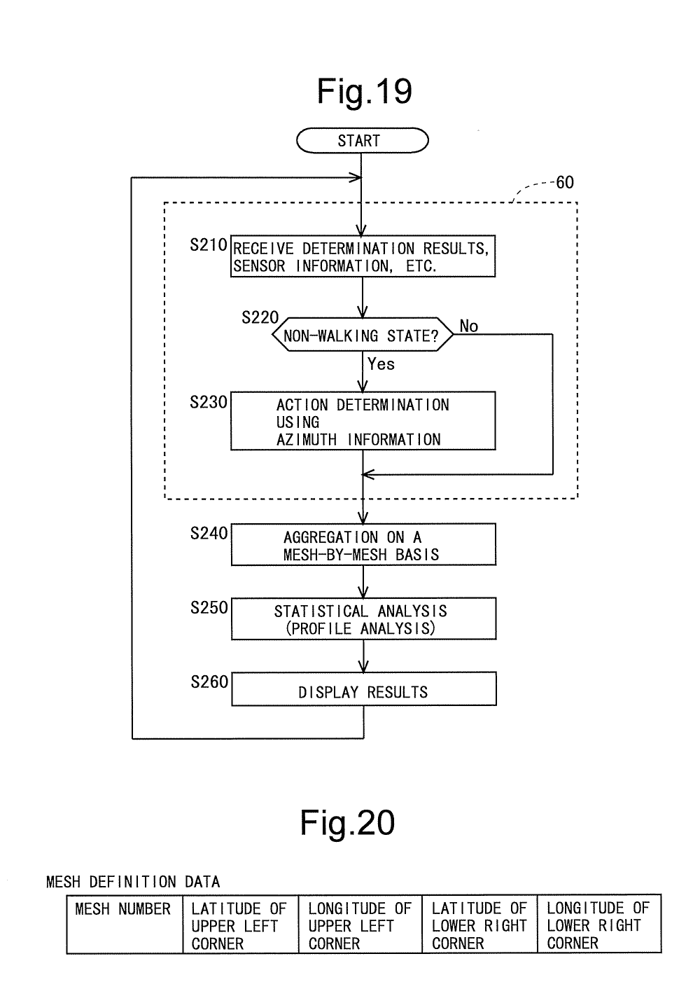

FIG. 19 is a flowchart showing a procedure of processes performed by the server 20. Every time each portable terminal device 10 transmits the above-described analysis data (various types of determination results, sensor information, etc.) Ada, the server 20 receives the analysis data Ada by the data receiving means 200 (S210).

Meanwhile, as described above, in the present embodiment, while a walking determination by each portable terminal device 10 is made every five seconds, the transmission of analysis data Ada from each portable terminal device 10 to the server 20 is performed every five minutes. Therefore, analysis data Ada transmitted at a time includes data for each five second time point. That is, analysis data Ada transmitted at a time can include both of data determining that “the user is in a walking state” and data determining that the “user is in a non-walking state”. Hence, after receiving analysis data Ada, a determination is made as to whether the analysis data Ada includes data (every five-second data) determining that “the user is in a non-walking state” (step S220). If, as a result of the determination, the corresponding data is present, processing proceeds to step S230, and if the corresponding data is not present, processing proceeds to step S240.

At step S230, the use-of-azimuth-information action determining means 240 makes an action determination using azimuth information Hda regarding a user of a corresponding portable terminal device 10. At this step S230, first, a range of (user's) orientation angles per unit of time is obtained based on azimuth information Hda included in the analysis data Ada. Then, based on the obtained range of orientation angles and the geographic profiles Gpr, various determinations are made to estimate a user's detailed action. Specific examples of determinations made at step S230 are shown below. Note, however, that the present invention is not limited to the examples shown below, and it is sufficient to make determinations depending on the purpose.

The range of orientation angles per unit of time is compared with a predetermined threshold value, and if the range of orientation angles is less than the threshold value, determinations described in the following (E-1) to (E-4) are made, and if the range of orientation angles is greater than or equal to the threshold value, determinations described in the following (E-5) to (E-6) are made. Note that a user's location is obtained from location information Pda included in the analysis data Ada.
(E-1): If the user's location is in front of a store (e.g., a souvenir shop), it is determined that “the user is interested in the store (the user is, for example, looking at commodities in the store or standing in line)”.
(E-2): If the user's location is a scenic site, it is determined that “the user is watching the scenery”.
(E-3): If the user's location is a crosswalk, it is determined that “the user is waiting at a traffic light”.
(E-4): If the user's location is simply on a road, it is determined that “the user is standing and talking”.
(E-5): If the user's location is in a store (e.g., a souvenir shop), it is determined that “the user is looking for a commodity”.
(E-6): If the user's location is simply on a road, it is determined that “the user is lost”.

Note that although here the range of orientation angles per unit of time is compared with the predetermined threshold value, different threshold values maybe used for the different determinations described in (E-1) to (E-6).

The server 20 performs the processes from step S210 to S230 such as those described above (processes included in a dotted-line box given reference character 60 in FIG. 19) for each portable terminal device 10. Therefore, data (the results of walking determinations, the results of various types of action determinations, etc.) about users of the multiple portable terminal devices 10 which allows for statistical action analysis is obtained.

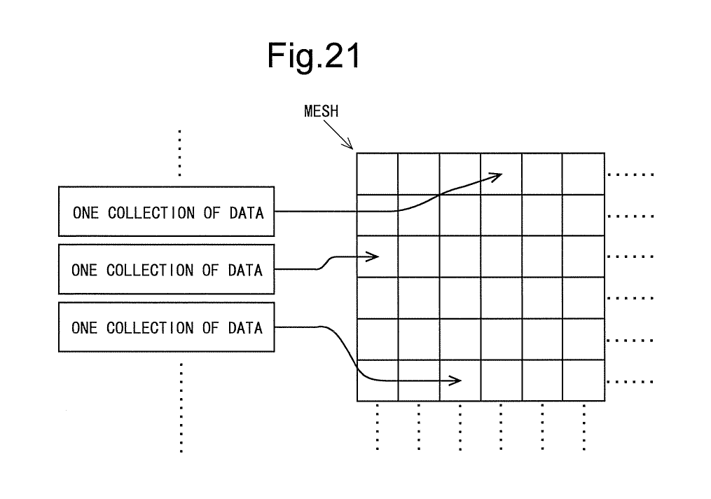

At step S240, the data obtained at the processes at step S210 to S230 is aggregated on a mesh-by-mesh basis. In other words, a process of allocating data to meshes on a per collection of data (e.g., data obtained every unit of time) basis is performed. Regarding this, the server 20 pre-holds, as data that defines each mesh, mesh definition data having a record format such as that shown in FIG. 20, for example. As shown in FIG. 20, the mesh definition data includes information on the latitude and longitude of an upper left corner and information on the latitude and longitude of a lower right corner for each mesh. In addition, the analysis data Ada transmitted from the portable terminal devices 10 to the server includes location information Pda. By the above, as schematically shown in FIG. 21, one collection of data can be allocated to a corresponding mesh, based on the location information Pda and the mesh definition data. Note that depending on the purpose, the process at step S240 does not necessarily need to be performed.

Meanwhile, at step S140 (see FIG. 6), the portable terminal device 10 makes a determination (congestion determination) as to whether the state of a user's current location is a congestion state or a non-congestion state. By aggregating results obtained by the congestion determination on a mesh-by-mesh basis, the congestion degree for each mesh can be obtained. By thus aggregating data on a mesh-by-mesh basis, mesh-by-mesh analysis can be performed for various types of information.

After the completion of step S240, the profile analyzing means 260 performs a process of statistically analyzing the actions of the users (the users of the plurality of portable terminal devices 10), using various types of profiles (geographic profiles Gpr, temporal profiles Tpr, and personal profiles Ppr included in the analysis data Ada), and based on the data obtained in the processes at step S210 to S240 (step S250). Specific examples of information that a user of the action analysis system wants to obtain by the statistical analysis at step S250 and a method for obtaining the information are shown below.

### SPECIFIC EXAMPLE 1

Information that the user wants to obtain: Scenic spots at which women in their 30s are likely to stop
Method for obtaining the information: Data on “women in their 30s” is extracted from analysis data Ada based on personal profiles Ppr. (here, age group and gender). Using the extracted data and the geographic profiles Gpr, a stop rate of each location specified as a scenic spot is calculated. The stop rate as used herein is obtained by, for example, dividing “the number of users that are determined in the above-described determination (E-2) such that “the user is watching the scenery” regarding a corresponding location” by “the number of users having passed through the corresponding location”. Then, the stop rate is compared with a predetermined threshold value, and if the stop rate is greater than or equal to the threshold value, it is determined that the corresponding location is a “scenic spot at which women in their 30s are likely to stop”.

### SPECIFIC EXAMPLE 2

Information that the user wants to obtain: Places at which Chinese people are likely to stop
Method for obtaining the information: Data on “Chinese” is extracted from analysis data Ada based on personal profiles Ppr (here, nationality). Using the extracted data, an average value per day of the number of users that are determined in the walking determination at step S120 (see FIG. 6) such that “the user is in a non-walking state” is obtained for each place (for each range of a predetermined size). Then, the obtained average value is compared with a predetermined threshold value, and if the average value is greater than or equal to the threshold value, it is determined that the place is a “place at which Chinese people are likely to stop”.

### SPECIFIC EXAMPLE 3

Information that the user wants to obtain: Corners at which tourists aged over 50 are likely to get lost
Method for obtaining the information: Data on “tourists aged over 50” is extracted from analysis data Ada based on personal profiles Ppr (here, age group and address). Note that a determination as to whether a corresponding user is a tourist is made by, for example, comparing a distance from an address to a current location with a predetermined threshold value. Using the extracted data and the geographic profiles Gpr, a lost rate of each location specified as a corner is calculated. The lost rate is obtained by, for example, dividing “the number of users that are determined in the above-described determination (D-2) or (E-6) such that “the user is lost” regarding a corresponding location” by “the number of users having passed through the corresponding location”. Then, the lost rate is compared with a predetermined threshold value, and if the lost rate is greater than or equal to the threshold value, it is determined that the corresponding location is a “corner at which tourists aged over 50 are likely to get lost”.

### SPECIFIC EXAMPLE 4

Information that the user wants to obtain: Places at which many people stop by on a rainy day
Method for obtaining the information: Data on “rainy day” is extracted from analysis data Ada based on temporal profiles Tpr (here, weather). Based on the extracted data, an average value of the number of users (an average value per day on a rainy day) that are determined in the walking determination at step S120 such that “the user is in a non-walking state” is obtained for each place (for each range of a predetermined size). Then, the obtained average value is compared with a predetermined threshold value, and if the average value is greater than or equal to the threshold value, it is determined that the place is a “place at which many people stop by on a rainy day”.

### SPECIFIC EXAMPLE 5

Information that the user wants to obtain: Stores in which people are interested for each age group
Method for obtaining the information: Using analysis data Ada and the geographic profiles Gpr, a stop rate of the location of each store is calculated. At that time, the stop rate is calculated for every 10 years of age, based on personal profiles Ppr. The stop rate as used herein is obtained by, for example, dividing “the number of users that are determined in the walking determination at step S120 such that “the user is in a non-walking state” regarding a corresponding location” by “the number of users having passed through the corresponding location”. Then, the stop rate is compared with a predetermined threshold value on an age-group-by-age-group basis, and a store present at a location where the stop rate is greater than or equal to the threshold value is determined to be a “store in which people in a corresponding age group are interested”.

### SPECIFIC EXAMPLE 6

Information that the user wants to obtain: Abnormality occurrence places
Method for obtaining the information: Using analysis data Ada and the geographic profiles Gpr, a stop rate of a location “where a stop is not supposed to take place other than stores, crosswalks, bus stops, etc.” is calculated every 15 minutes. The stop rate as used herein is obtained by, for example, dividing “the number of users that are determined in the walking determination at step S120 such that “the user is in a non-walking state” regarding a corresponding location” by “the number of users having passed through the corresponding location”. Then, the stop rate is compared with a predetermined threshold value, and a place present at a location where the stop rate is greater than or equal to the threshold value is determined to be an “abnormality occurrence place” (a place where a crowd of people has gathered). Note that it is also possible that the congestion degree is obtained instead of the stop rate, the obtained congestion degree is compared with a predetermined threshold value, and a place present at a location where the congestion degree is greater than or equal to the threshold value is determined to be an “abnormality occurrence place”.

A result of the determination of “abnormality occurrence place” can be used, for example, to handle a case in which a crowd of people has gathered such as upon holding an event or upon the occurrence of unexpected trouble. That is, when a crowd of people has been found, security guards, etc., can be immediately sent to that place and thus a dangerous situation can be resolved in a short period of time.

As described above, at step S250 (see FIG. 19), by performing statistical analysis, various information can be obtained regarding users' actions. In addition to the above, as further specific examples, for example, information such as that shown below can be obtained.
Places where many tourists take a rest in the morning
A time period during which public toilets get crowded
A relationship between a destination of a user and a place where the user is likely to get lost
A place where congestion occurs and a time period therefor
A store that gets crowded and a time period therefor
A relationship between a place where an event takes place and stores that are advantageously affected thereby

In addition, based on information obtained by the statistical analysis at step S250, for example, determinations such as those shown below are made.
Many people get lost at a location just outside of a subway station.
A location in front of a given hall is used as a meeting place in the evening.
Near a given bus stop, congestion occurs every time a bus arrives.

After performing the statistical analysis (step S250), information indicating users' actions is displayed on the display unit 27 of the server 20, based on an operation of the operator of the server 20 (step S260). At this step S260, based on the analysis data Ada held in the data storing means 210, the results obtained by the aggregation at step S240, and the results obtained by the statistical analysis at step S250, desired information can be displayed as information indicating users' actions.

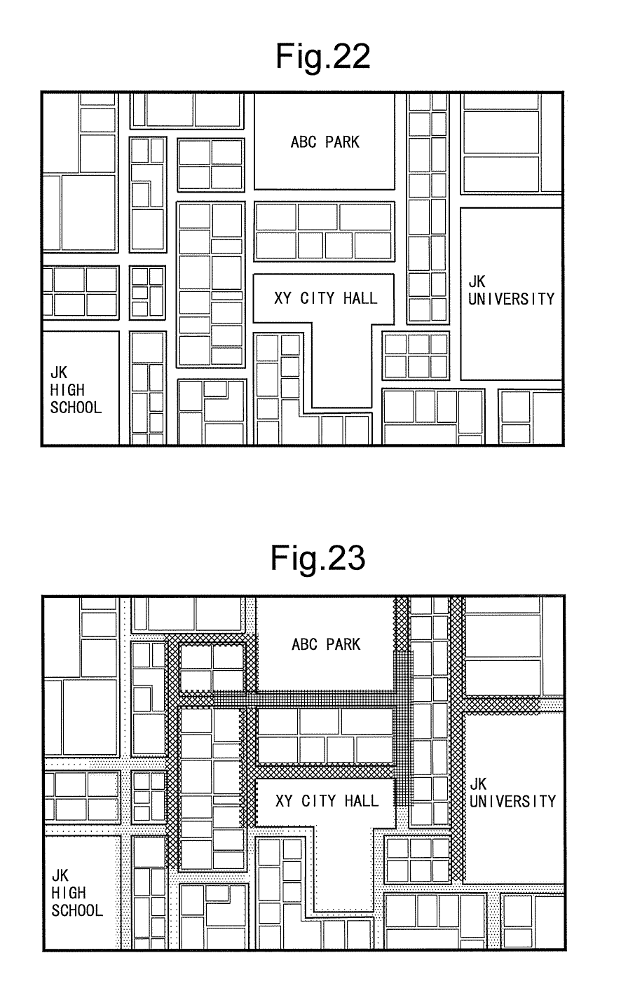

At step S260, pieces of desired information can be displayed on a screen displaying a map such that the pieces of desired information are associated with locations on the map. For example, it is assumed that the operator wants to display information on the average congestion degrees of roads (sidewalks) for a given time period (e.g., one hour from 8:00 a.m. to 9:00 a.m.). At this time, for example, a screen is displayed on which, as shown in FIG. 23, patterns depending on the congestion degree are provided to roads on a map such as that shown in FIG. 22. As such, in the example shown in FIG. 23, pieces of information on the congestion degree are displayed so as to be associated with locations on the map. Note that the congestion degree can be obtained, for example, based on the result of a determination at the above-described step S140 (see FIG. 6). In addition, such pieces of information on the congestion degree can also be displayed, for example, in heat-map mode.

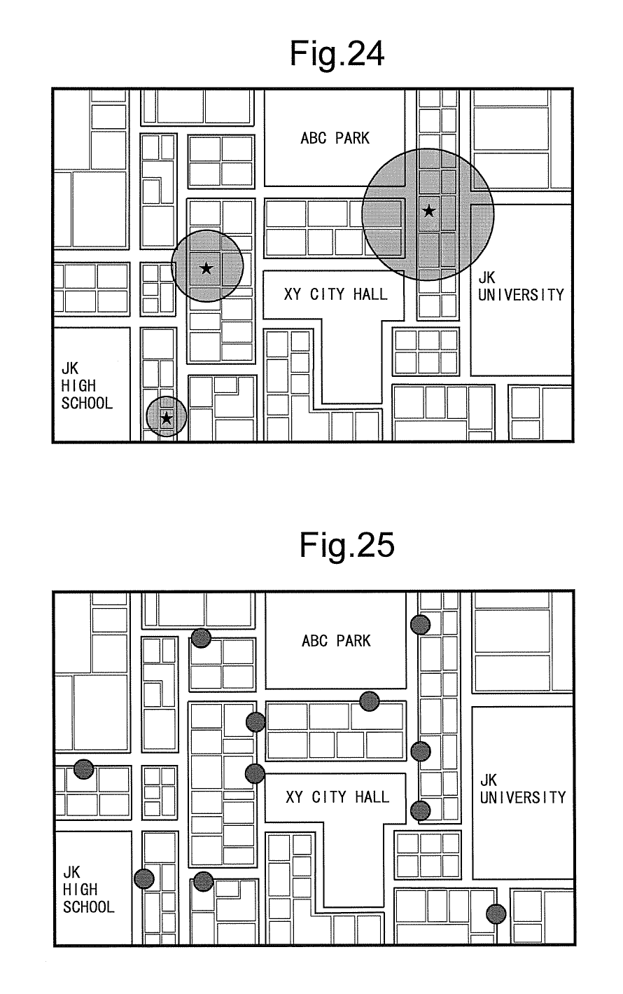

In addition, at step S260, pieces of desired information can be displayed on a screen displaying a map such that the pieces of desired information are associated with geographic profiles Gpr. For example, it is assumed that the operator wants to visually display the numbers of guests at Japanese restaurants. At this time, for example, a screen is displayed on which, as shown in FIG. 24, circles of sizes depending on the number of guests (shaded circles) are provided on a map such as that shown in FIG. 22 such that the locations of Japanese restaurants are at the center of the circles. Since the attribute information “Japanese restaurant” is a geographic profile Gpr indicating the type of store, in the example shown in FIG. 24, pieces of information indicating the magnitude of the number of guests are displayed so as to be associated with geographic profiles Gpr. Note that in FIG. 24 the locations of the Japanese restaurants are indicated by filled star symbols.

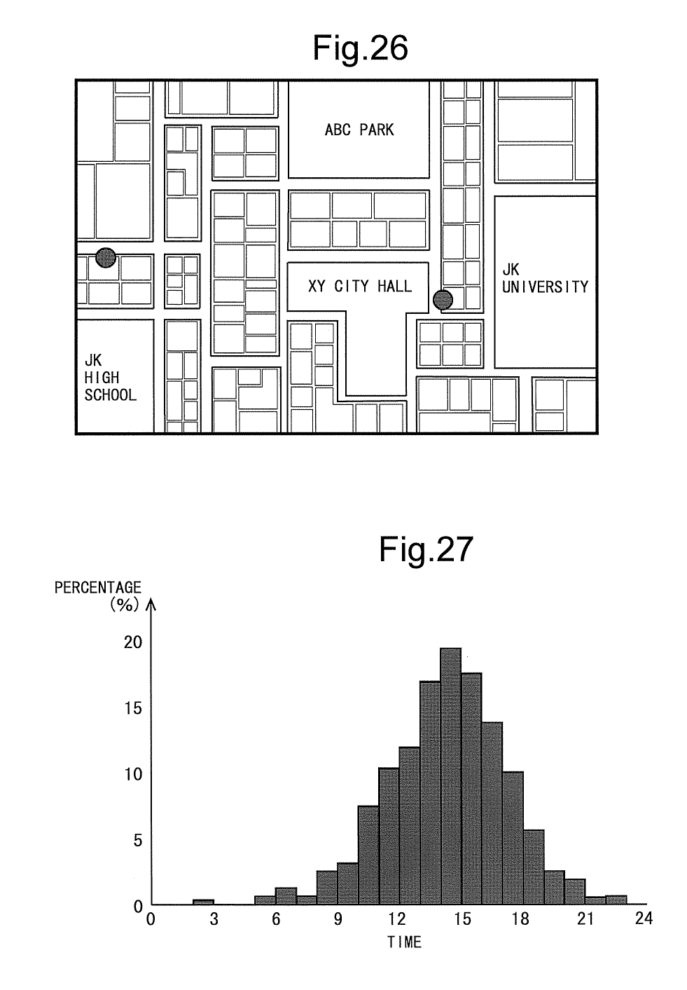

Furthermore, at step S260, filtering can also be performed based on various types of profiles. For example, it is assumed that when locations at which people are likely to stop during a given time period are displayed on a map, a screen such as that shown in FIG. 25 is displayed. Note that in FIG. 25 the locations at which people are likely to stop are indicated by filled circles. At this time, by performing filtering based on personal profiles Ppr, for example, information limited to “men in their 60s” can be displayed. By this, after the filtering, for example, a screen such as that shown in FIG. 26 is displayed. In FIG. 26, only locations at which men in their 60s are likely to stop during the above-described time period are indicated by filled circles.

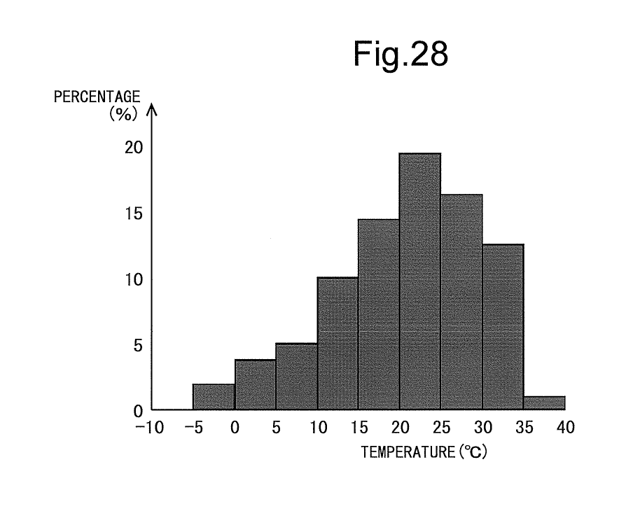

Meanwhile, a screen displayed at step S260 is not always displayed with a map. For example, information indicating users' actions can also be displayed in a format such as a bar graph. Regarding this, for example, as shown in FIG. 27, the occurrence rate of a given action can also be displayed in an hour-by-hour bar graph (i.e., a time-varying graph). In addition, for example, as shown in FIG. 28, the occurrence rate of a given action can also be displayed in a temperature-by-temperature (five-degree intervals in the example shown in FIG. 28) bar graph. As such, information summed up for each profile can also be displayed. As described above, at step S260, information indicating users' actions can be displayed in various display modes.

The server 20 repeats the processes at step S210 to S260 such as those described above.

### <1.5 Effects>

According to the present embodiment, a determination as to whether a user of a portable terminal device 10 is in a walking state or a non-walking state is made based on information (sensor information) obtained by sensors mounted on the portable terminal device 10. Then, depending on the determination result, a process of determining user's movement and action is further performed based on various types of sensor information (acceleration information Sda, azimuth information Hda, and location information Pda). By using the sensor information in this manner, user's detailed movement can be grasped, and thus, a user's specific action can be accurately estimated. In addition, the server 20 performs a process of statistically analyzing users' actions using various types of profiles (geographic profiles Gpr, temporal profiles Tpr, and personal profiles Ppr). Hence, the results of analyzing the users' actions on a profile-by-profile basis (on a store-type-by-store-type basis, on a weather-by-weather basis, on an-age-group-by-age-group basis, etc.) can be obtained. By this, regarding the users' actions, a profile-by-profile trend can be grasped. In the above-described manner, it becomes possible to grasp what people are taking what stop action (shopping, photo taking, getting lost, etc.) at what place. In addition, the transmission of analysis data Ada from each portable terminal device 10 to the server 20 is performed without the need for a user's operation. Therefore, information generated on each portable terminal device 10 is efficiently collected on the server 20. Furthermore, determination processes regarding movement and an action are performed at timing close to real-time.

By the above, according to the present embodiment, it becomes possible to efficiently obtain beneficial information about actions of the users of the portable terminal devices 10, and specifically analyze the users' actions. By this, it becomes possible to grasp what interests people have, and as a result, it becomes possible to appropriately and efficiently perform, for example, marketing, urban planning, store design, and event planning.

In addition, in the present embodiment, determinations that can be made based only on information obtained by the portable terminal device 10 are made on the portable terminal device 10. Hence, unnecessary sensor information is prevented from being transmitted from the portable terminal devices 10 to the server 20, and thus, an increase in the load on the communication line and the server 20 is prevented.

### 2. Second Embodiment

### <2.1 Summary and Configuration>

A second embodiment of the present invention will be described. In the above-described first embodiment, a determination (walking determination) as to whether a user is in a walking state or in a non-walking state is made, and an action determination is made depending on the determination result. On the other hand, in the present embodiment, determinations for user's movement and action are made without making a walking determination. The following mainly describes differences from the above-described first embodiment.

The overall configuration, the hardware configuration of the portable terminal devices 10, and the hardware configuration of the server 20 are the same as those of the first embodiment (see FIGS. 1 to 3). The detailed functional configuration of the action analysis system is substantially the same as that of the first embodiment (see FIG. 4). Note, however, that in the present embodiment the movement determining means 110 determines user's movement based only on the standard deviation of acceleration obtained from acceleration information Sda, without performing a walking determination, and outputs a determination result R(A). The determination result R(A) includes at least information by which whether a user is stopping can be identified.

### <2.2 Action Analysis Method>

An action analysis method of the present embodiment will be described. A schematic procedure of an action analysis process is the same as that of the first embodiment (see FIG. 5).

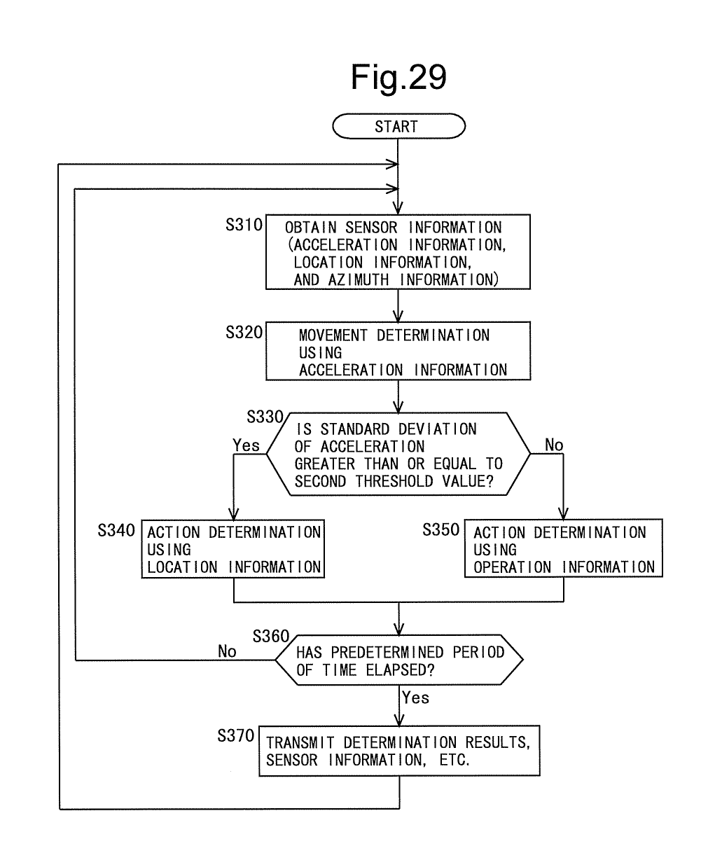

FIG. 29 is a flowchart showing a procedure of processes performed by each portable terminal device 10 in the present embodiment. First, as in the first embodiment, sensor information is obtained (step S310). Then, the movement determining means 110 makes a movement determination using acceleration information Sda (step S320). At this step S320, first, as in step S140 in the first embodiment (see FIG. 6), for example, standard deviation of acceleration for the last 10 seconds is calculated. Then, three threshold values (first to third threshold values) for comparing with the standard deviation are prepared, and determinations such as those described in the following (F-1) to (F-4) are made. Note that for the three threshold values, for example, the combination “the first threshold value: 0.15, the second threshold value: 0.05, and the third threshold value: 0.005” can be adopted (the unit is m/s²).
(F-1): If the standard deviation is greater than or equal to the first threshold value, it is determined that “user's movement is large and the user is passing through a corresponding place without stopping”.
(F-2): If the standard deviation is greater than or equal to the second threshold value and less than the first threshold value, it is determined that “user's movement is somewhat small, though not to the extent of stopping (the state of the current location is a congestion state)”.
(F-3): If the standard deviation is greater than or equal to the third threshold value and less than the second threshold value, it is determined that “the user is walking as stopping sometimes, e.g., doing window shopping”.
(F-4): If the standard deviation is less than the third threshold value, it is determined that “the user is staying at a corresponding place (e.g., something that attracts user's interest such as a tourist object or a commodity is present at the corresponding place)”.

If the determination (F-1) or (F-2) is made in the above-described movement determination (i.e., if the standard deviation is greater than or equal to the second threshold value), processing proceeds to step S340, and if the determination (F-3) or (F-4) is made in the above-described movement determination (i.e., if the standard deviation is less than the second threshold value), processing proceeds to step S350 (step S330).

At step S340, S350, S360, and S370, the same processes as those at step S142, S152, S160, and S170 in the first embodiment (see FIG. 6) are performed, respectively.

The server 20 performs the same processes as those of the first embodiment (FIG. 19). Note, however, that at step S220 shown in FIG. 19, a determination as to whether a corresponding user is stopping is made based on the result of a movement determination. Regarding this, if the determination (F-1) or (F-2) is made at the above-described step S320, it is determined at step S220 that “the corresponding user is not stopping”, and if the determination (F-3) or (F-4) is made at the above-described step S320, it is determined at step S220 that “the corresponding user is stopping”.

In the above-described manner, determinations for user's movement and action are made without making a walking determination. In addition, as in the first embodiment, the server 20 performs statistical analysis using various types of profiles and displays various types of results on the display unit 27.

### <2.3 Effects>

In the present embodiment, too, as in the first embodiment, it becomes possible to efficiently obtain beneficial information about actions of the users of the portable terminal devices 10, and specifically analyze the users' actions. In addition, in the present embodiment, the portable terminal devices 10 do not perform a walking determination process. Hence, the load on the portable terminal devices 10 can be reduced over the first embodiment.

### 3. Others

The present invention is not limited to the above-described embodiments and can be performed by making various modifications thereto without departing from the spirit and scope of the present invention. For example, although an action analysis program for implementing an action analysis system is embedded in a tourist guide program in the above-described embodiments, the present invention is not limited thereto. For example, the action analysis program may be embedded in a program of coupon apps for various types of stores. By this, a user of the action analysis system can analyze users' detailed actions in a store. By the analysis, for example, information can be obtained such as the attributes of people having an interest in each commodity and the percentage of people who have actually purchased a corresponding commodity among people showing their interest in each commodity. Then, the thus obtained information can be utilized, for example, for commodity display. In addition, by grasping users' actions in real time, for example, it becomes possible to promote the purchase of a commodity by presenting an advertisement, etc., to purchase candidates at effective timing.

In addition, upon determining users' actions, information other than the information used in the above-described embodiments may be used. For example, when purchase information obtained from a POS system is linkable to user information of the portable terminal devices 10, users' actions can be determined using the purchase information.

Furthermore, although, in the above-described embodiments, a movement determination (including a walking determination and a congestion determination), an action determination using location information Pda, and an action determination using operation information Mda are made on the portable terminal devices 10, and an action determination using azimuth information Hda is made on the server 20, the present invention is not limited thereto. When an increase in the data amount of analysis data Ada which is transmitted from the portable terminal devices 10 to the server 20 is allowable, for example, all determinations may be made on the server 20. In addition, by allowing the portable terminal devices 10 to hold geographic profiles Gpr, an action determination using azimuth information Hda can be made on the portable terminal devices 10.

Although the present invention has been described in detail above, the above description is to be considered in all respects as illustrative and not restrictive. It will be understood that many other changes and modifications may be made without departing from the spirit and scope of the present invention.

Note that this application claims priority to Japanese Patent Application No. 2017-25874 titled “Action Analysis Method, Action Analysis Program, and Action Analysis System” filed Feb. 15, 2017, the content of which is incorporated herein by reference.

What is claimed is:

1. An action analysis method for analyzing an action of a user of a portable terminal device, the method comprising:
a sensor information obtaining step of obtaining sensor information from one or more sensors mounted on the portable terminal device;
a movement determining step of determining movement of the user based on the sensor information; and
an action determining step of determining, depending on a determination result obtained in the movement determining step, an action of the user based on the sensor information.

2. The action analysis method according to claim 1, wherein
the sensor information includes acceleration information obtained from an acceleration sensor, and
the movement determining step includes:
a walking determining step of determining, based on the sensor information, whether the user is in a walking state or in a non-walking state; and
a use-of-acceleration-information movement determining step of determining movement of the user based on standard deviation of acceleration obtained, from the acceleration information, when it is determined that the user is in a non-walking state in the walking determination step.

3. The action analysis method according to claim 2, wherein the movement determining step further includes a congestion determining step of determining, when it is determined that the user is in a walking state in the walking determining step, whether a state of a current location of the user is a congestion state or a non-congestion state, based on the standard deviation of acceleration obtained from the acceleration information.

4. The action analysis method according to claim 1, wherein
the sensor information includes acceleration information obtained from an acceleration sensor, and
in the movement determining step, movement of the user is determined based on standard deviation of acceleration obtained from the acceleration information.

5. The action analysis method according to claim 1, wherein
the sensor information includes azimuth information obtained from an azimuth sensor, and
the action determining step includes a use-of-azimuth-information action determining step of determining an action of the user based on the azimuth information.

6. The action analysis method according to claim 5, wherein the determination in the use-of-azimuth-information action determining step is made taking into account a relationship between the azimuth information and geographic attribute information prepared in advance.

7. The action analysis method according to claim 1, wherein
the sensor information includes location information obtained from a location sensor, and
the action determining step includes a use-of-location-information action determining step of determining an action of the user based on the location information.

8. The action analysis method according to claim 1, wherein the action determining step includes a use-of-operation-information action determining step of determining an action of the user based on operation information, the operation information being information about an operation performed by the user on the portable terminal device.

9. The action analysis method according to claim 1, further comprising an action information displaying step of displaying pieces of information on a predetermined screen based on determination results obtained in the action determining step regarding users of a plurality of portable terminal devices, the pieces of information indicating actions of the users.

10. The action analysis method according to claim 9, wherein in the action information displaying step, the pieces of information indicating the actions of the users can be displayed on a screen displaying a map such that the pieces of information are associated with locations on the map.

11. The action analysis method according to claim 10, wherein in the action information displaying step, the pieces of information indicating the actions of the users can be displayed so as to be associated with pieces of geographic attribute information prepared in advance.

12. The action analysis method according to claim 9, further comprising a statistical analysis step of statistically analyzing the actions of the users based on the determination results obtained in the action determining step and predetermined attribute information, regarding the users of the plurality of portable terminal devices, wherein
in the action information displaying step, results obtained in the statistical analysis step can be displayed as the information indicating the actions of the users.

13. The action analysis method according to claim 12, wherein when the results obtained in the statistical analysis step are displayed in the action information displaying step, filtering can be performed based on at least one of personal attribute information obtained from the plurality of portable terminal devices, geographic attribute information prepared in advance, and temporal attribute information prepared in advance.

14. A computer-readable recording medium having recorded therein an action analysis program for analyzing an action of a user of a portable terminal device, the action analysis program causing a computer to perform:
a sensor information obtaining step of obtaining sensor information from one or more sensors mounted on the portable terminal device;
a movement determining step of determining movement of the user based on the sensor information; and
an action determining step of determining, depending on a determination result obtained in the movement determining step, an action of the user based on the sensor information.

15. An action analysis system configured by a server and a plurality of portable terminal devices, and analyzing actions of users of the plurality of portable terminal devices, the server and the plurality of portable terminal devices being connected to each other through a network, the action analysis system comprising:
a movement determining unit configured to determine movement of a user of each portable terminal device based on sensor information obtained from one or more sensors mounted on each portable terminal device; and
an action determining unit configured to determine, depending on results obtained by the determination made by the movement determining unit, an action of the user of each portable terminal device based on the sensor information.

16. The action analysis system according to claim 15, wherein regarding determinations made by the action determining unit, a determination that can be made based only on information obtained by each portable terminal device is made on each portable terminal device, and other determinations are made on the server.

17. The action analysis system according to claim 15, wherein
the movement determining unit is provided in each portable terminal device,
the action determining unit includes a portable-side action determining unit provided in each portable terminal device; and a server-side action determining unit provided in the server, and
results obtained by determinations made by the movement determining unit and the portable-side action determining unit, and sensor information required for a determination by the server-side action determining unit, are transmitted from each portable terminal device to the server.

18. The action analysis system according to claim 15, wherein
the sensor information includes acceleration information obtained from an acceleration sensor mounted on each portable terminal device, and
the movement determining unit includes:
a walking determining unit configured to determine, based on the sensor information, whether the user is in a walking state or in a non-walking state; and
a use-of-acceleration-information movement determining unit configured to determine movement of the user based on standard deviation of acceleration obtained, from the acceleration information, when the walking determining unit determines that the user is in a non-walking state.

19. The action analysis system according to claim 18, wherein the movement determining unit further includes a congestion determining unit configured to determine, when the walking determining unit determines that the user is in a walking state, whether a state of a current location of the user is a congestion state or a non-congestion state, based on the standard deviation of acceleration obtained from the acceleration information.

20. The action analysis system according to claim 15, wherein
the sensor information includes acceleration information obtained from an acceleration sensor mounted on each portable terminal device, and
in each portable terminal device, the movement determining unit determines movement of the user based on standard deviation of acceleration obtained from the acceleration information.
